(19) United States
(12) Patent Application Publication
(10) Pub. No.: US 2003/0140456 A1
(43) Pub. Date: Jul. 31, 2003

(54) Pivotal hinge and slitting conical elastic pad

(76) Inventors: Chung Nan Hsieh, Hsinchu (TW); Wen Hao Tai, Shinjuang City (TW)

Correspondence Address: Ladas & Parry, 26 West 61st Street, New York, NY, 10023, US

(21) Appl. No.: 10/135,090

(22) Filed: Apr. 29, 2002

(30) Foreign Application Priority Data
Jan. 30, 2002 (TW) 91200975

(51) Int. Cl. E05D 11/08

(52) U.S. Cl. 16/340

(57) ABSTRACT

A pivotal hinge of which the axial elastic force may be adjusted through elastic pads is disclosed. The pivotal hinge comprises a pivotal member, a positioning bracket, a pivotal bracket and at least one elastic pad. Due to the adjustable axial elastic force, the frictional pivot contact between the positioning and pivotal brackets may be varied.

### FIELD OF THE INVENTION

The present invention relates to a pivotal hinge, particularly to a pivotal hinge which can adjust the degree of pivot contact for pivoting between the LCD display and the main unit of a laptop computer or electronic dictionary.

### BACKGROUND OF INVENTION

LCD displays and main units of conventional portable computers are generally pivotally assembled together by a pair of pivotal hinges. To comply with the low price strategy adopted for the portable computer market, there is a need to provide an improved pivotal hinge which is not only simple in structure but also can obtain the intended effects so as to reduce the production cost.

### SUMMARY OF THE INVENTION

According to an embodiment of the specification, the low-cost pivotal hinge of the present invention simply comprises a pivotal member, a positioning bracket, a pivotal bracket, at least one elastic pad, wherein the above members are secured together by a fastening member. The pivotal member comprises a shaft member formed with at least one non-pivotal structure. The positioning bracket is passed by the shaft member for non-rotatable installation. The positioning bracket further comprises a positioning arm coupled to the non-pivotal structure of the shaft member so that it cannot be rotated or pivoted. The pivotal bracket has a swinging arm which is rotatably passed by the shaft for installation so that it can be rotated between a first position and a second position. At least one slitting conical elastic pad is rotatably installed to the shaft member to provide an axial elastic force thereto. In addition, the present invention provides a mechanism by which users can adjust the axial elastic force so as to increase or decrease the friction contact between the members installed to the shaft member so that the pivoting speed can be adjusted because the pivoting resistance is adjustable. When the pivotal hinge of the present invention is applied on a portable computer, its adjustable pivoting resistance allows the speed of the pivoting action between the main unit and the LCD display to be changed by adjusting the frictional pivot contact between the positioning and pivotal brackets.

The above and other features and advantages of the present invention may be realized from the accompanying drawings and the following descriptions.

### BRIEF DESCRIPTION OF THE DRAWINGS

FIG. 1 is an exploded perspective view of a first embodiment of the present invention;

FIG. 2 is an assembled perspective view of the embodiment of FIG. 1;

FIGS. 3a-3c are schematic views illustrating an example slitting conical elastic pad of the present invention;

FIG. 4 is an exploded perspective view of a second embodiment of the present invention;

FIG. 5 is an assembled perspective view of the embodiment of FIG. 4;

FIG. 6 is an assembled perspective view of a third embodiment of the present invention;

FIG. 7 is an exploded perspective view of FIG. 6; and

FIG. 8 is an exploded perspective view of a forth embodiment of the present invention.

### DETAILED DESCRIPTION OF THE INVENTION

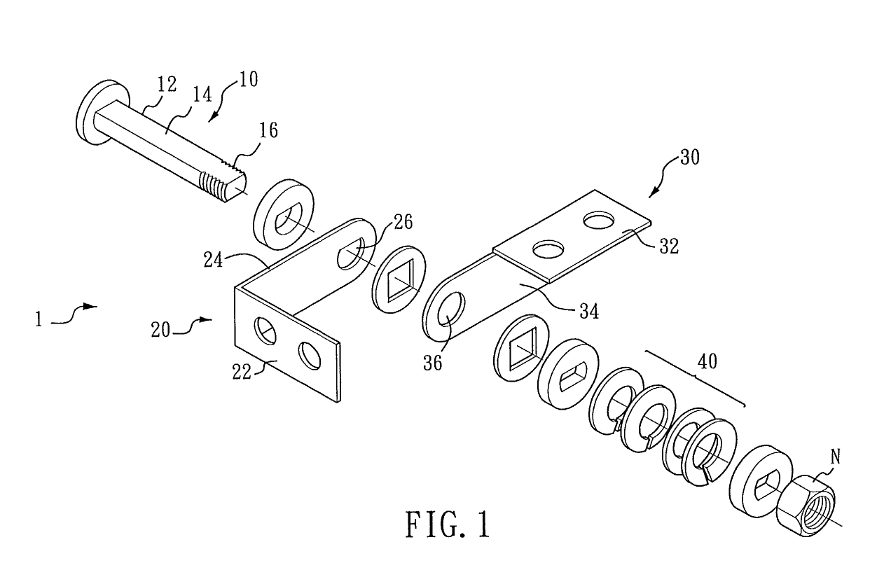

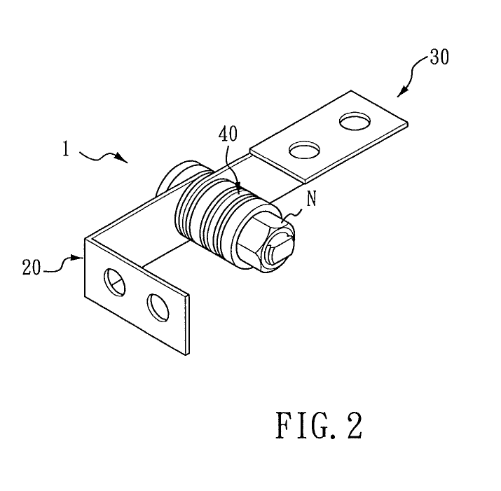

FIGS. 1 and 2 illustrate a pivotal hinge 1 according to a first embodiment of the present invention. The pivotal hinge 1 generally comprises a pivotal member 10, a positioning element preferably in the form of a positioning bracket 20, a pivotal bracket 30, and at least one slitting conical elastic pad 40. The end of the pivotal hinge 10 is secured by a fastening member N.

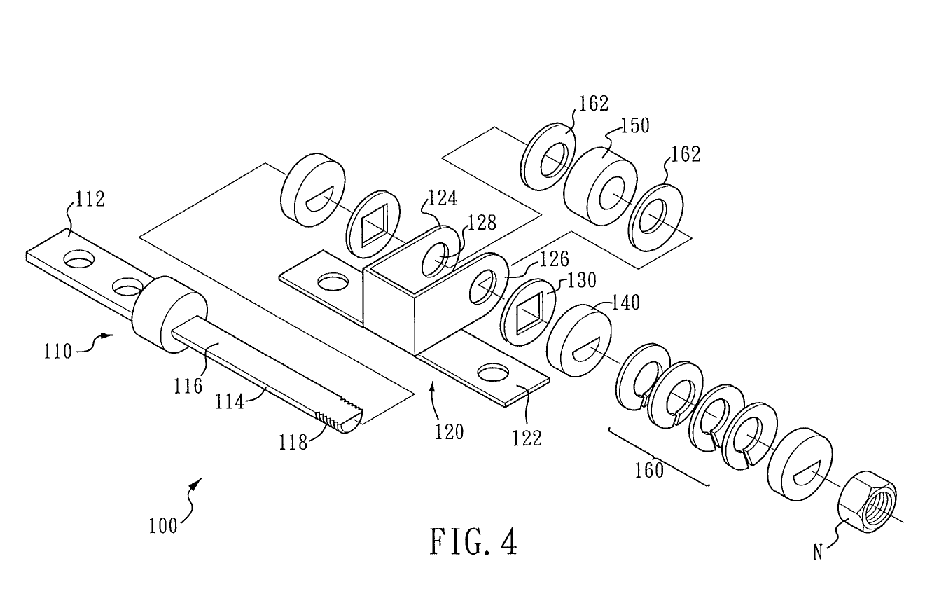

The pivotal member 10 comprises a shaft member 12 extending along an axis (not shown). The shaft member 12 is formed with at least one non-pivotal structure 14 for non-pivotably or non-rotatably coupling. The non-pivotal structure 14 may be either in the form of transverse planes that extends along both the top and bottom surfaces of the shaft member 12, or in the form of a transverse plane that extends along one of said surfaces. See the non-pivotal structure 116 of FIG. 4. The end of shaft member 12 of pivotal member 10 may comprise a locking part 16 in the form of a threaded section for engaging a fastening member N preferably in the form of a nut.

The positioning element is used to mount a pivotal member 10 to a main unit or an LCD display (not shown). A simple example of positioning element is illustrated by the positioning bracket 20 of FIG. 1, which comprises a mounting part 22 and a positioning arm 24 which are mounted on the main unit or display. The positioning arm 24 is preferably assembled to the shaft member 12 by a non-pivotal hole 26 and couples to at least one non-pivotal structure 14 so as to avoid a relative rotation between the positioning arm 24 and the shaft member 12.

The pivotal bracket 30 comprises a mounting part and a swinging arm which can be mounted onto an LCD display or a main unit. The swinging arm 34 is rotatably passed by shaft member 12, for example, by providing a pivotal hole 36.

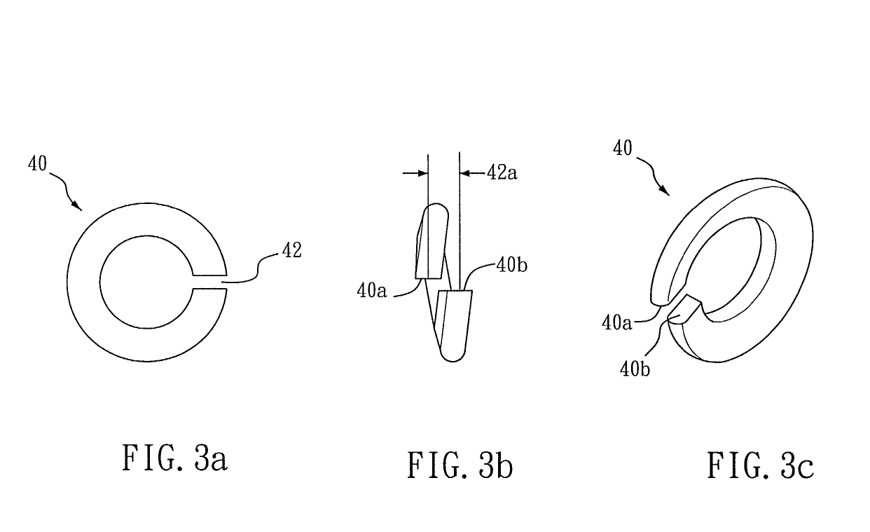

Each of the slitting conical elastic pad 40 generally extends helically into an open ring with a slit 42 defined by ends 40a, 40b thereof, as shown in FIGS. 3a to 3c. Specifically, the slitting conical elastic pad 40 shapes into a conical configuration which inclines from its inner diameter to outer diameter at a conical angle. This conical configuration allows the slitting conical elastic pad 40 to sustain a higher compression force than prior art planar pads. Preferably, the ends 40a, 40b are offset spaced from each other at the stit 42 by a predetermined gap 42a so as to provide a conical elastic pad 40 of a biasing slitting form. The predetermined offset gap 42a increases the elasticity of the pad 40 such that the pad 40 can withstand a much higher compression force. The provision of an offset gap 42a between the ends 40a, 40b of the pad 40 is similar to the concept of exerting a preload on a conventional pad. That is, any force that is exerted on the biasing slitting conical elastic pad will first be absorbed by the offset gap 42a until the gap 42a disappears. According to the above, the slitting conical elastic pad 40 is advantageous in providing an axial elastic force on the members mounted to the shaft member 12 so that said members can be elastically abutted to each other. Users can easily adjust this axial elastic force by means of the mating structure of the locking part 16 and the fastening member N, so as to adjust the friction pivot contact of the positioning bracket 20 relative to the pivotal bracket 30.

A waste-free and environmentally friendly process of manufacturing biasing slitting conical elastic pads is depicted herein. First, prepare a wire material (usually a steel wire) and subject the wire material to a drawing step under normal temperature then to a rolling step so as to obtain a drawn wire with a generally square cross section. Then, curl the drawn wire helically similar to the shaping of a helical spring and simultaneously shape the surface of the drawn and rolled wire with a conical angle under the aid of a jig during curling. After the conical angle is formed, subject the curled wire to a laser-cutting step (fused by high-temperature laser beam focusing) to cut the curled wire into an open ring-shaped segments so as to obtain conical elastic pads. At this time, the conical elastic pads may optionally be further shaped with punch press to obtain bias-free pads with better flatness. Finally, subject the elastic pads to a heat-treating step to obtain a reinforced structure with enhanced elasticity and prolonged lifespan. The aforesaid process features the following advantages: (1) as the whole process uses the laser beam to cut the curled wire, no waste material is produced; (2) the product obtained hereof costs less and is produced at faster speed than conventional elastic pads produced by stamping; (3) the product obtained thereof has greater stretchability and elasticity than the pads of prior art; and (4) the use of steel wire gives the product greater stability and longer lifespan than the pads made by the conventional process.

As indicated above, after the pivotal shaft member 10, positioning element or positioning bracket 20, pivotal bracket 30 and the slitting conical elastic pads 40 are assembled to the shaft member 12, the fastening member N is secured to the locking part 16 to secure these members in place. When the fastening member N is pushed or threaded inward, the slitting conical elastic pads 40 will be compressed, such that the members 10, 20, 30 on the shaft member 12 are tightly compressed together. This increases the contact friction between the members 10, 20, 30 and thus increases the pivotal resistance against the pivotal action between the pivotal bracket 30 and positioning element (positioning bracket 20). On the contrary, as the fastening member N is pushed or threaded outward, the slitting conical elastic pads will be released, such that the pivotal resistance between the pivotal bracket 30 and positioning element (positioning bracket 20) is decreased.

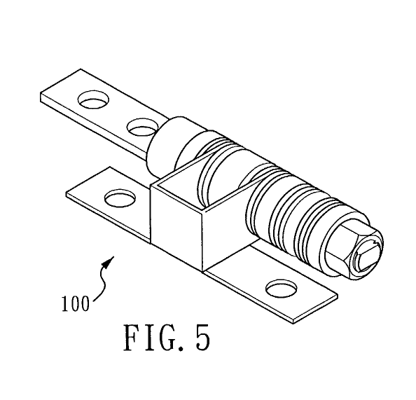

FIGS. 4 and 5 show a second embodiment of a pivotal hinge 100 according to the present invention, which comprises a pivotal member 110, a pivotal bracket 120, at least one friction member 130, 140, 150 and at least one slitting conical elastic pad 160. The end of the pivotal hinge 110 is secured by a fastening member N.

The pivotal member 110 comprises a mounting part 112 and a shaft member 114, wherein the mounting part 112 is intended to be mounted to a main unit (not shown). The shaft member 114 is formed with at least one non-pivotal structure 116 for preventing rotation. The non-pivotal structure 116 may be either in the form of a single transverse plane on shaft member 114, or in the form of transverse planes that extend at both of the top and bottom of the shaft member 114, similar to the shaft member 12 of FIG. 1. The end of shaft member 114 of pivotal member 110 may comprise a locking part 118 preferably in the form of a threaded section for engaging a fastening member N in the form of a nut. The mounting part 112 can either be integrated with or separable from the pivotal member 110.

The pivotal bracket 120 comprises a mounting part 122 and first and second receiving portions 124, 126 which are parallel to each other. The mounting part 122 is used to be mounted to an LCD display (not shown). The first and second receiving portions 124, 126 are respectively formed with a pivotal hole 128 which allows the shaft member 114 to pass therethrough and to be supported thereby.

The at least one friction member 130, 140, 150 is mounted to the shaft member 110 and disposed between members 110, 120, 160, so as to obtain a greater frictional contact between the members 110, 120, 160. More specifically, the friction members 130, 140, 150 may optionally constitute either pads 130 or frictional blocks 140 that can engage with the non-pivotal structure 116 to prevent rotation, or of a sleeve 150 that is rotatable around shaft member 114. According to this second embodiment, the friction members 130, 140, 150 comprise a sleeve 150 disposed between the first and second receiving portions 124, 126. Preferably, at least one end of the sleeve 150 is provided with a conical elastic pad 162 without a slit to allow the sleeve 150 to be tightly but rotatably clamped between the first and second receiving portions 124, 126. If necessary, it is also allowed to provide pads 130 or larger friction blocks 140 between the first and second receiving portions 124, 126 for a non-rotatable coupling with the non-pivotal structure 116.

The slitting conical elastic pads 160 are used to provide an axial elastic force to the members 110, 120, 160 mounted on the shaft member 114, similar to the slitting conical elastic pads 40 of FIGS. 1-3. This axial elastic force my be adjusted according to the user's needs by adjusting the relative locking position of the fastening member N relative to the locking part 118 to compress or release the slitting conical elastic pads 160 disposed between the members 110, 120, 160, similar to the slitting conical elastic pads 40 of FIG. 1. By this way, the pivotal hinge 100 has adjustable pivoting resistance so that its pivoting speed can be adjusted.

After the pivotal member 110, pivotal bracket 120, friction members 130, 140, 150 and slitting conical elastic pads 160 are properly installed to the shaft member 114, the fastening member N is secured or preferably screwed to the locking part 118. If the fastening member N is moved or threaded inwards, the slitting conical elastic pads 160 will be compressed, and at the same time the pivotal member 110, pivotal bracket 120, and friction members 130, 140, 150 on the shaft member 114 will be tightly compressed together. This increases the frictional contact between the members 110, 120, 130, 140 and 150 such that the pivoting resistance of the pivotal bracket 120 is increased. On the contrary, if the fastening member N is moved or threaded outwards, the pressure on the slitting conical elastic pads 160 is released, thereby decreasing the pivoting resistance of the pivotal bracket 120.

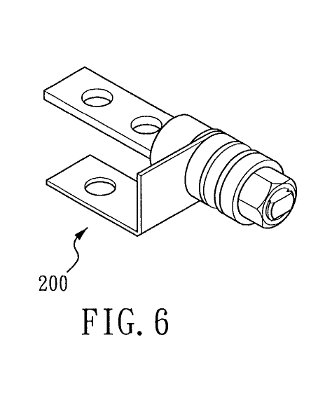

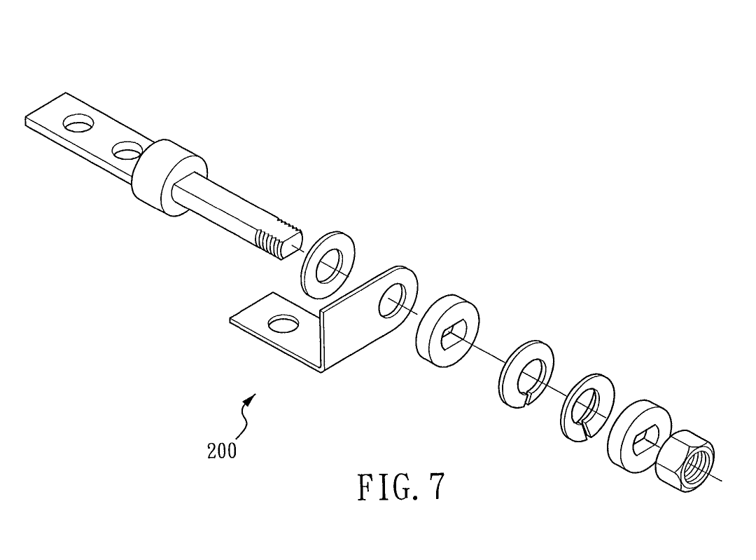

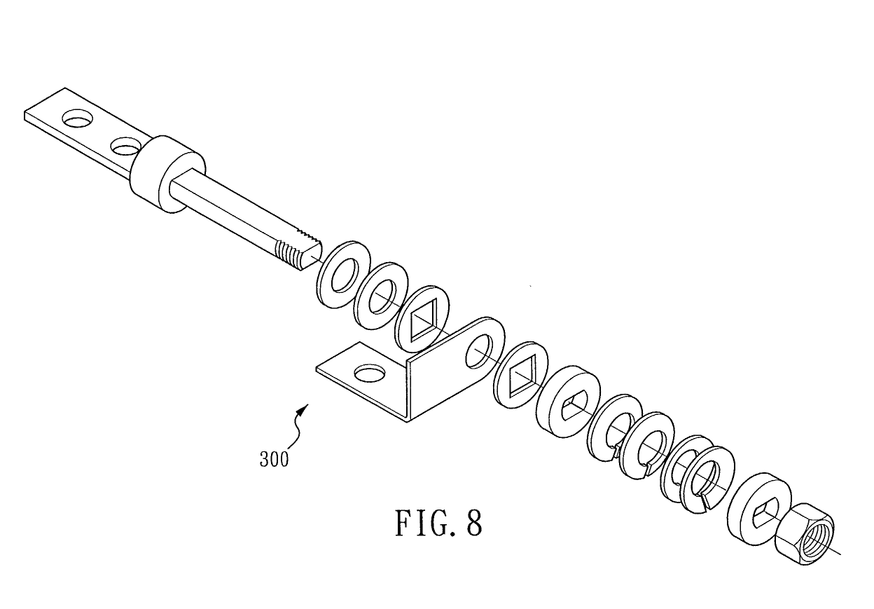

FIGS. 6 to 8 illustrate a single-arm type (i.e., the pivotal bracket contains a single receiving portion) of pivotal hinges 200, 300 according to the third and fourth embodiments of the present invention, which uses the same theory of the pivotal hinge 100 of the second embodiment. Because pivotal hinges 200, 300 have only one receiving portion, they are more appropriate to be installed in pairs to both ends of the junction between the main unit and the LCD display.

As the invention has been particularly described with respect to preferred embodiments thereof, persons skilled in the art will understand that the above and other changes in form and detail may be made without departing from the scope and spirit of the invention.

What is claimed is:

1. A pivotal hinge for pivoting between a main unit and an LCD display, comprising:
a pivotal member having a shaft member extending along an axis, wherein the shaft member comprises at least one non-pivotal structure for preventing rotation; the pivotal member being mounted to one of the main unit and the LCD display by a positioning element, the first swinging arm being rotatably passed by the shaft member;
at least one slitting conical elastic pad passing through the shaft member to provide an axial elastic force thereto, said at least one slitting conical elastic pad extending helically into an open ring with a slit defined by two ends of the slitting conical elastic pad, said pad shaping into a conical configuration which inclines from its inner diameter to outer diameter at a conical angle; and
wherein a free end of the shaft member is secured by a fastening member which is adaptable to adjust said axial elastic force.

2. The pivotal hinge as set forth in claim 1, wherein the positioning element is a position bracket having a mounting part and a positioning arm, the mounting part being mounted to the other of said one of the main unit and LCD display, the mounting part passing through the shaft member and coupling to said at least one non-pivotal structure.

3. The pivotal hinge as set forth in claim 1, wherein the free end of the pivotal end comprises a locking part in the form of a threaded section for engaging a fastening member in the form of a nut.

4. The pivotal hinge as set forth in claim 1, wherein said two ends of the at least one slitting conical elastic pad are offset from each other by a predetermined gap.

5. A pivotal hinge for pivoting between a main unit and an LCD display, comprising:
a pivotal member having a mounting part and a shaft member extending along an axis, wherein the mounting part is mounted to the main unit and the shafting member comprises at east one non-pivotal structure for non-pivotal coupling;
a pivotal bracket comprising a mounting part and a first receiving portion, wherein the mounting part is mounted to the LCD display and the first receiving portion allows the shaft member to pass therethrough and to be supported thereby;
at least one friction member, said at least one friction member being mounted to and passed by the shaft member and engageable with said non-pivotal structure;
at least one slitting conical elastic pad passing through the shaft member to provide an axial elastic force thereto, said at least one slitting conical elastic pad extending helically into an open ring with a slit defined by two ends of the slitting conical elastic pad, said pad shaping into a conical configuration which inclines from its inner diameter to outer diameter at a conical angle; and
wherein a free end of the shaft member is secured by a fastening member which is adaptable to adjust said axial elastic force.

6. The pivotal hinge as set forth in claim 5, wherein said two ends of the at least one slitting conical elastic pad are offset from each other by a predetermined gap.

7. The pivotal hinge as set forth in claim 5, wherein the pivotal bracket further comprises a second receiving portion parallel to the first receiving portion.

8. The pivotal hinge as set forth in claim 7, wherein the at least one friction member comprises pads disposed between the first and second receiving portions and non-pivotably coupling to the non-pivotal structure of the shaft member.

9. The pivotal hinge as set forth in claim 7, wherein the at least one friction member comprises a friction block disposed between the first and second receiving portions and non-pivotably coupling to the non-pivotal structure of the shaft member.

10. The pivotal hinge as set forth in claim 7, wherein the at least one friction member comprises a sleeve disposed between the first and second receiving portions.

11. The pivotal hinge as set forth in claim 10, wherein the sleeve has two ends, at lease one of said two ends being provided with a conical elastic pad without a slit so that the sleeve can be tightly but rotatably abutted between the first and second receiving portions.

12. The pivotal hinge as set forth in claim 5, wherein the mounting part of the pivotal member can either be integrated with the pivotal member or be a separable member which couples to the pivotal member.

13. A slitting conical elastic pad generally extending helically into an open ring with a slit, wherein the slitting conical elastic pad has two ends to define said slit and shapes into a conical configuration which inclines from its inner diameter to outer diameter at a conical angle.

14. The slitting conical elastic pad as set forth in claim 13, wherein the ends of the slitting conical elastic pad are offset from each other by a predetermined gap.

15. A process of manufacturing a slitting conical elastic pads, comprising the steps of:
a) preparing a wire material;
b) subjecting the wire material to a drawing step under normal temperature then to a rolling step so as to obtain a drawn wire with a generally square cross section;
c) curling the drawn and rolled wire helically similar to the shaping of a helical spring while simultaneously shaping the surface of the drawn and rolled wire with a conical angle under the aid of a jig during curling; and
d) subjecting the curled wire to a laser-cutting step to cut the curled wire into an open ring-shaped segments so as to obtain conical elastic pads.

16. The process of claim 15, wherein the step d) is followed by a step e) of: heat-treating the elastic pads to a heat-treating step to obtain a reinforced structure with enhanced elasticity and prolonged lifespan.

17. The process of claim 15, wherein the step d) is followed be a step f) of: shaping the conical elastic pads by punch press to obtain bias-free pads with better flatness.
